(19) United States
(12) Patent Application Publication
(10) Pub. No.: US 2020/0002465 A1
(43) Pub. Date: Jan. 2, 2020

(54) RESIN COMPOSITION, MOLDED ARTICLE, LAMINATE, COATING MATERIAL, AND ADHESIVE

(71) Applicants: DIC Corporation, Tokyo (JP); National Institute of Advanced Industrial Science and Technology, Tokyo (JP)

(72) Inventors: Tomoaki Harada, Sakura-shi (JP); Yusho Usami, Sakura-shi (JP); Michiya Nakashima, Sakura-shi (JP); Takeo Ebina, Sendai-shi (JP); Ryo Ishii, Sendai-shi (JP); Takafumi Aizawa, Sendai-shi (JP)

(21) Appl. No.: 16/489,708

(22) PCT Filed: Mar. 13, 2018
(86) PCT No.: PCT/JP2018/009769

§ 371 Date: Aug. 29, 2019

(30) Foreign Application Priority Data
Mar. 14, 2017 (JP) 2017-049132

(51) Int. Cl. C08G 59/24; C08G 59/22; C08G 59/42; C08G 59/44; C08G 59/62; C08G 59/50; C08K 3/34; C09D 163/00; C09D 7/61; C09J 163/00; C09J 11/04; B32B 27/38

(52) U.S. Cl. CPC C08G 59/245; C08G 59/24; C08G 59/22; C08G 59/4238; C08G 59/44; C08G 59/621; C08K 2201/008; C08K 3/346; C09D 163/00; C09D 7/61; C09J 163/00; C09J 11/04; B32B 27/38; C08G 59/5026

(57) ABSTRACT

A resin composition contains an epoxy compound and a smectite with partially immobilized lithium.

### TECHNCAL FIELD

The present invention relates to a resin composition, a molded article, a laminate, a coating material, and an adhesive.

### BACKGROUND ART

Packaging materials used to package food or similar things are required to have functions such as the protection of their contents, retort resistance, heat resistance, transparency, and workability. To keep the contents in good condition, gas barrier properties are particularly important. Recently, not only packaging materials but also materials for electronic materials, including solar cells and semiconductors, have become required to have high gas barrier properties.

In PTL 1, it is described that combining a resin having a hydroxyl group and an isocyanate compound with a sheet inorganic compound, such as a clay mineral, and a light-screening agent improves gas barrier and other characteristics.

PTL 2, moreover, describes a material that is primarily modified clay. According to PTL 2, the use of modified clay, optionally with additives, and arraying crystals of the modified clay into dense layers gives a film material that has a mechanical strength high enough that the material can be used as a self-supporting membrane, gas barrier properties, waterproofness, heat stability, and flexibility.

### CITATION LIST

### Patent Literature

PTL 1: International Publication No. 2013/027609

PTL 2: Japanese Unexamined Patent Application Publication No. 2007-277078

### SUMMARY OF INVENTION

### Technical Problem

Sheet inorganic compounds of the type described in PTL 1 are bulky, and with such a compound, it is difficult to achieve good compatibility with resins. This means there is a limit to how much such a compound can be added and to its dispersibility. It is therefore difficult to achieve even higher gas barrier properties by adding more of such a compound, and even if it were possible to increase the amount of filler added, dispersibility could not be sufficient, and the gas barrier properties could not be sufficient.

As for the clay membrane described in PTL 2, the substrate on which the clay membrane is formed (e.g., a resin substrate) is required to have very high heat resistance because the membrane is made into a self-supporting membrane by heating after its formation. Usable only with a substrate having very high heat resistance (e.g., a resin substrate), therefore, the viscosity membrane described in PTL 2 has the disadvantage of limited use. Furthermore, the self-supporting membrane described in PTL 2 contains much filler so that it will exhibit high gas barrier properties. Too much filler, however, causes the disadvantage, for example if the membrane is used in film applications for soft packaging, of a lack of flexibility of the film because the filler affects the softness of the composition. For this reason, there remains a need for a resin composition that exhibits high gas barrier properties regardless of whether it has a high or low filler content.

An object of the present invention is therefore to provide a resin composition even better than existing resin compositions in gas barrier properties, in particular water vapor and oxygen barrier properties.

### Solution to Problem

An aspect of the present invention provides a resin composition that contains an epoxy compound and a smectite with partially immobilized lithium. By virtue of the combination of an epoxy compound and a smectite with partially immobilized lithium, this resin composition is superior in gas barrier properties, such as water vapor and oxygen barrier properties (e.g., oxygen barrier properties under high-humidity conditions). That is, this resin composition gives a resin film that has excellent gas barrier properties.

The epoxy compound preferably has an epoxy equivalent weight of 50 to 3000 g/eq. This makes the resin composition even better in water vapor and oxygen barrier properties.

The epoxy compound preferably contains at least one structure of an aromatic ring structure and an aliphatic ring structure. This makes the resin composition even better in water vapor and oxygen barrier properties.

The smectite with partially immobilized lithium preferably has a cation exchange capacity of 1 to 70 meq/100 g. This makes the resin composition even better in water vapor and oxygen barrier properties.

The resin composition may be one that further contains at least one curing agent. If containing a curing agent, the resin composition gives a resin film even better in barrier properties because it can be cured through heat-induced ring-opening polymerization of epoxy groups.

The curing agent is preferably at least one selected from the group consisting of acid anhydride-based curing agents, phenolic curing agents, and amide-based curing agents. That is, the resin composition preferably contains at least one of these curing agents. This makes the resin composition even better in water vapor and oxygen barrier properties.

The smectite with partially immobilized lithium is preferably present in an amount of 3% to 70% by mass based on the total nonvolatile content of the resin composition. Such an amount results in a resin composition even better in formability as well as superior in water vapor and oxygen barrier properties.

The present invention, in an aspect, provides an article molded from a resin composition as described above and a laminate having this molded article on a substrate (laminate including a substrate and a molded article on the substrate).

The resin composition according to an aspect of the present invention is suitable for use in applications such as gas barrier materials, coating materials, and adhesives by virtue of being superior in water vapor and oxygen barrier properties.

### Advantageous Effects of Invention

The present invention makes it possible to provide a resin composition even better in gas barrier properties, in particular water vapor and oxygen barrier properties.

### Description of Embodiments

The following describes preferred embodiments of the present invention in detail. The present invention, however, is not limited to these embodiments.

A resin composition according to this embodiment contains an epoxy compound and a smectite with partially immobilized lithium.

Smectite is a kind of sheet-structured phyllosilicate mineral (sheet clay mineral). Known specific structures of smectite include montmorillonite, beidellite, saponite, hectorite, stevensite, and sauconite. Of these, as the structure(s) of a clay material, at least one structure selected from the group consisting of montmorillonite and stevensite is preferred. In these structures, a metal element in octahedral sheets has been partially replaced, for example with a lower-valency metal element resulting from isomorphous substitution or with a defect. The octahedral sheets are therefore negatively charged. As a consequence, these structures have vacant sites in their octahedral sheets, and in smectites having these structures, as discussed hereinafter, lithium ions can exist stably after movement.

A smectite in which the retained cation is the lithium ion is referred to as a lithium smectite (Smectites with partially immobilized lithium as described hereinafter are excluded.). An example of a method for exchanging a cation in a smectite with the lithium ion is a cation exchange by adding a lithium salt, such as lithium hydroxide or lithium chloride, to a liquid dispersion (dispersion slurry) of a natural sodium smectite. By controlling the amount of lithium added to the liquid dispersion, the quantity of lithium ions in the cation leaching from the resulting lithium smectite can be controlled to an appropriate level. A lithium smectite can alternatively be obtained by a column or batch process that uses a cation-exchange resin that retains lithium ions as a result of ion exchange.

In an embodiment, a smectite with partially immobilized lithium refers to a lithium smectite in which a subset of the lithium ions are immobilized in vacant sites in the octahedral sheets. A smectite with partially immobilized lithium is obtained as a result of the immobilization of interlayer lithium ions into vacant sites in the octahedral sheets, for example through the heating of a lithium smectite. The immobilization of lithium ions makes the smectite waterproof.

The temperature conditions for the heating for the partial immobilization of lithium are not critical as long as lithium ions can be immobilized. As discussed hereinafter, a small cation exchange capacity (CEC) will lead to a greater improvement in the water vapor and oxygen barrier properties of the resin composition containing the smectite with partially immobilized lithium. It is therefore preferred to heat the lithium smectite at 150° C. or above so that the heating will immobilize lithium ions efficiently and thereby reduce the cation exchange capacity greatly. The temperature for the heating is more preferably between 150° C. and 600° C., even more preferably between 180° C. and 600° C., in particular between 200° C. and 500° C., the most preferably between 250° C. and 500° C. Heating at such temperatures ensures higher efficiency in reducing the cation exchange capacity and, at the same time, helps prevent events such as the dehydration of hydroxyl groups in the smectite. The heating is performed preferably in an open electric furnace. This ensures that the relative humidity is 5% or less and the pressure is atmospheric pressure during heating. The duration of the heating is not critical as long as lithium can be partially immobilized, but preferably is between 0.5 and 48 hours, more preferably between 1 and 24 hours, in light of production efficiency.

Whether the resultant substance is a smectite with partially immobilized lithium or not can be determined by x-ray photoelectron spectroscopy (XPS). Specifically, in the XPS spectrum measured by XPS, the position of the binding energy peak attributable to the Li ion is checked. For example, if the smectite is montmorillonite, changing the lithium smectite into a smectite with partially immobilized lithium, for example by heating, will shift the position of the binding energy peak attributable to the Li ion in the XPS spectrum from 57.0 ev to 55.4 ev. If the smectite is montmorillonite, therefore, whether the spectrum has a 55.4-ev binding energy peak is the criterion for whether the smectite is a partially immobilized type or not.

The cation exchange capacity of the smectite with partially immobilized lithium is preferably 70 meq/100 g or less, more preferably 60 meq/100 g or less so that the resin composition will be even better in water vapor and oxygen barrier properties (e.g., oxygen barrier properties under high-humidity conditions). The cation exchange capacity of the smectite with partially immobilized lithium is 1 meq/100 g or more, more preferably 5 meq/100 g or more, even more preferably 10 meg/100 g or more so that the resin composition will be even better in water vapor and oxygen barrier properties (e.g., oxygen barrier properties under high-humidity conditions). In light of these, the cation exchange capacity of the smectite with partially immobilized lithium is between 1 and 70 meq/100 g, more preferably between 5 and 70 meq/100 g, even more preferably between 10 and 60 meq/100 g. If the smectite is montmorillonite, for example, the cation exchange capacity is usually between about 80 and 150 meq/100 g, but partial immobilization will reduce it to between 5 and 70 meq/100 g. The cation exchange capacity of the smectite with partially immobilized lithium may be less than 60 meq/100 g or may even be 50 meq/100 g or less. For example, the cation exchange capacity of the smectite with partially immobilized lithium may be 1 meq/100 g or more and less than 60 meq/100 g, may be 5 meq/100 g or more and less than 60 meq/100 g, or may be 10 meq/100 g or more and less than 60 meq/100 g.

The cation exchange capacity of a smectite can be measured by a method based on Schollenberger's process (the Third Edition of the Handbook of Clays and Clay Minerals, edited by the Clay Science Society of Japan, May 2009, pp. 453-454). More specifically, it can be measured by the method set forth in Japan Bentonite Association. Standard test method JBAS-106-77.

The cation leaching from a smectite can be calculated by leaching interlayer cations in the smectite using 100 mL of 1 M aqueous solution of ammonium acetate per 0.5 g of smectite over at least 4 hours and measuring the concentrations of cations in the resulting solution, for example by ICP emission spectrometry or atomic absorption spectrometry.

The amount of the smectite with partially immobilized lithium is preferably 3% by mass or more of the total nonvolatile content of the resin composition. If the amount of the smectite with partially immobilized lithium is 3% by mass or more of the total nonvolatile content, the resin composition is even better in water vapor and oxygen barrier properties (e.g., oxygen barrier properties under high-humidity conditions). In the same light, the amount of the smectite with partially immobilized lithium may be 5% by mass or more, 7% by mass or more, 9% by mass or more, 10% by mass or more, 15% by mass or more, 18% by mass or more, 20% by mass or more, 25% by mass or more, or 30% by mass or more of the total nonvolatile content of the resin composition. The amount of the smectite with partially immobilized lithium is preferably 70% by mass or less of the total nonvolatile content of the resin composition. If the amount of the smectite with partially immobilized lithium is 70% by mass or less, the resin composition is even better in formability and is improved in adhesion to a substrate. The oxygen barrier properties under high-humidity conditions also become higher. In the same light, the amount of the smectite with partially immobilized lithium may be 50% by mass or less, 45% by mass or less, 40% by mass or less, 35% by mass or less, or 30% by mass or less of the total nonvolatile content of the resin composition. These upper and lower limits can be paired in any combination. That is, the amount of the smectite with partially immobilized lithium may be, for example, between 3% and 70% by mass, between 3% and 50% by mass, between 3% and 35% by mass, between 5% and 35% by mass, between 5% and 30% by mass, between 7% and 30% by mass, between 9% and 30% by mass, or between 10% and 30% by mass of the total nonvolatile content of the resin composition. In similar statements herein, too, the specified upper and lower limits can be paired in any combination. The nonvolatile content is defined as the mass that is left after subtracting the mass of diluents and the mass of volatile components in the epoxy resin, in curing agents, in modifiers, and in additives from the total mass of the resin composition.

A resin composition according to an embodiment contains an epoxy compound. Epoxy compound refers to a compound that contains an epoxy group. Examples of epoxy compounds include condensates of an active hydrogen compound (preferably a compound having two or more active hydrogens) with epichlorohydrin, oxides of olefins, and polymers of ethylenic unsaturated compounds having a glycidyl group, such as glycidyl (meth)acrylate. The condensates are typified by glycidyl-ether epoxy compounds, glycidyl-amine epoxy compounds, and glycidyl-ester epoxy compounds. Among these, glycidyl-ether epoxy compounds, which are condensates of a compound having two or more hydroxyl groups, such as bisphenol A, bisphenol F, or novolac, with epichlorohydrin, are particularly preferred. The epoxy compound may be solid or liquid. If the epoxy compound is solid, it may be dissolved in a solvent before use.

The epoxy equivalent weight of the epoxy compound is preferably 50 g/eq or more, more preferably 100 g/eq or more. An epoxy equivalent weight equal to or higher than 50 g/eq or more ensures that the molded article obtained by curing a film of the resin (cured film) is superior in flexibility. The epoxy equivalent weight of the epoxy compound may be 5000 g/eq or less, preferably 3000 g/eq or less, more preferably 2500 g/eq, even more preferably 2200 g/eq. An epoxy equivalent weight equal to or lower than 3000 g/eq results in a resin composition even better water vapor and oxygen barrier properties (e.g., oxygen barrier properties under high-humidity conditions). In light of these, the epoxy equivalent weight of the epoxy compound may be, for example, between 50 and 5000 g/eq, between 50 and 3000 g/eq, between 50 and 2500 g/eq, between 50 and 2200 g/eq, between 100 and 3000 g/eq, between 100 and 2500 g/eq, or between 100 and 2200 g/eq. The epoxy equivalent weight may be 150 g/eq or more or 180 g/eq or more or may be 2000 g/eq or less, 1500 g/eq or less, 1100 g/eq or less, 700 g/eq or less, or 500 g/eq. The epoxy equivalent weight can be measured in accordance with JIS K7236: 2001.

The epoxy compound preferably includes at least one structure of an aromatic ring structure and an aliphatic ring structure. In this case, the resin composition is even better in water vapor and oxygen barrier properties (e.g., oxygen barrier properties under high-humidity conditions). The reason why such an advantage is obtained is unclear, but one possible reason is that the resulting resin film becomes less compatible with water vapor by virtue of the epoxy compound containing such structure(s). The epoxy compound may include only one structure of an aromatic ring structure and an aliphatic ring structure or may include both structures. An epoxy compound including an aromatic ring structure is more preferred for use because with such a compound the above advantage can be obtained more easily. In the following, an epoxy compound that includes an aromatic ring structure is referred to as an “aromatic epoxy compound,” and an epoxy compound that includes an aliphatic ring structure is referred to as an “alicyclic epoxy compound.”

The aromatic ring structure in an aromatic epoxy compound may be a simple ring or fused ring. The aromatic ring structure is preferably a structure that has a C6-18 aromatic ring (divalent aromatic ring). Examples of such aromatic ring structures include the benzene ring structure (phenylene group), naphthalene ring structure (naphthylene group), phenanthrene ring structure (phenanthrenylene group), and anthracene ring structure (anthracenylene group). The aromatic ring structure is more preferably a benzene ring or naphthalene structure, even more preferably a benzene ring structure. An aromatic epoxy compound may include one or multiple aromatic ring structures.

Examples of aromatic epoxy compounds include bisphenol-A epoxy compounds, bisphenol-F epoxy compound, bisphenol-S epoxy compounds, bisphenol-AD epoxy compound, resorcinol epoxy compounds, dihydroxynaphthalene epoxy compounds, biphenyl epoxy compounds, and tetramethylbiphenyl epoxy compounds, epoxy compounds that are trifunctional or have more epoxy groups in the structure of anthracene, biphenyl, bisphenol A, bisphenol F, or bisphenol S, phenol-novolac epoxy compounds, cresol-novolac epoxy compounds, triphenylmethane epoxy compounds, tetraphenylethane epoxy compounds, epoxy compounds resulting from dicyclopentadiene-phenol addition reaction, phenol-aralkyl epoxy compounds, naphthol-novolac epoxy compounds, naphthol-aralkyl epoxy compounds, novolac epoxy compounds resulting from naphthol-phenol co-condensation, novolac epoxy compounds resulting from naphthol-cresol co-condensation, phenolic compound-based epoxy compounds modified with an aromatic hydrocarbon formaldehyde compound, and biphenyl-modified novolac epoxy compounds. Among these, bisphenol-A and bisphenol-F epoxy compounds are particularly preferred for use because with such a compound, the resin composition is even better in water vapor and oxygen barrier properties (e.g., oxygen barrier properties under high-humidity conditions). A bisphenol-A epoxy compound may be liquid or solid.

The aromatic epoxy compound may be a commercially available aromatic epoxy compound. Examples of commercially available aromatic epoxy compounds include phenyl diglycidyl ether (Nagase ChemteX Corporation “Denacol EX-141”) (Denacol is a registered trademark; the same applies hereinafter), p-tert-butylphenyl glycidyl ether (Nagase ChemteX Corporation “Denacol EX-146”), resorcinol diglycidyl ether (Nagase ChemteX Corporation “Denacol EX-201”), bisphenol-A diglycidyl ether (DIC Corporation “EPICLON 850, 850-S, 860, 1050, 2050, 3050, 4050, 7050, and HM-091”) (EPICLON is a registered trademark; the same applies hereinafter), bisphenol-F diglycidyl ether (DIC Corporation “EPICLON 830”), phenol-novolac polyglycidyl ether (DIC Corporation “EPICLON N-740 and 770,”), cresol-novolac polyglycidyl ether (DIC Corporation “EPICLON N-660”), a polydiglycicyl ether resulting from dicyclopentadiene-phenol addition reaction (DIC Corporation “EPICLON HP-7200”), 2-phenylphonol glycidyl ether (Nagase ChemteX Corporation “Denacol EX-142”), 1,6-naphthalene diglycidyl ether (DIC Corporation “EPICLON HP-4032, a 1-chloro-2,3-epoxypropane-2,7-naphthalenediol-formaldehyde polycondensate (DIC Corporation “EPICLON EXA-4700”), orthophthalic acid diglycidyl ether (Nagase ChemteX Corporation “Denacol EX-721”), terephthalic acid diglycidyl ether (Nagase ChemteX Corporation “Denacol EX-711”), 1,6 hexanediol diglycidyl ether (Nagase ChemteX Corporation “Denacol EX-212”), N,N,N′,N′-tetraglycidyl m-xylenediamine (Mitsubishi Gas Chemical Company, Inc. “TETRAD-X”), Mitsubishi Chemical Corporation's “jER806,” “jER4004P,” and “jER YX4000,” and ADEKA Corporation's “ADEKA RESIN EP-4100” and “ADEKA RESIN EP-4901.”

The aliphatic ring structure in an alicyclic epoxy compound may be a simple ring or fused ring. The aliphatic ring structure is preferably a cycloalkane structure. The number of carbon atoms in the cycloalkane structure may be 4 or more and may be 10 or less. For example, the cycloalkane structure may be a cyclopentane structure, cyclohexane structure, cycloheptane structure, cyclooctane structure, cyclononane structure, cyclodecane structure, etc. An alicyclic epoxy compound may include one or multiple aliphatic ring structures.

Examples of alicyclic epoxy compounds include cycloalkene oxide compounds and alicyclic polyhydric alcohol polyglycidyl ether compounds. The alicyclic epoxy compound may be a commercially available alicyclic epoxy compound. Examples of commercially available alicyclic epoxy compounds include 3,4-epoxycyclohexylmethyl-3′,4′-epoxycyclohexane carboxylate (Daicel Corporation “CELLOXIDE 2021P”) (CELLOXIDE is a registered trademark; the same applies hereinafter), 1,2:8,9 diepoxylimonene (Daicel. Corporation “CELLOXIDE 3000”), a dicyclopentadiene epoxy resin (DIC Corporation “EPICLON HP-7200”), hydrogenated bisphenol A diglycidyl ether (Nagase ChemteX Corporation “Denacol EX-252”), hexahydrophthalic acid diglycidyl ether (Sakamoto Yakuhin Kogyo Co., Ltd. “SR-HHPA”), 1,4-cyclohexane dimethanol diglycidyl ether (New Japan Chemical Co., Ltd. “RIKARESIN DME-100”), 1,3-bisaminomethylcyclohexane (Mitsubishi Gas Chemical Company, Inc.), 1,3-bis(N,N-diglycidylaminomethyl)cyclohexane (Mitsubishi Gas Chemical Company, Inc. “TETRAD-C”), a 1,2-epoxy-4-(2-oxiranyl)cyclohexane adduct of 2,2-bis(hydroxymethyl)-1-butanol (Daicel Corporation “EHPE3150”), and SYNASIA's “Syna-Epoxy 21” and “Syna-Epoxy 28.”

The epoxy compound may alternatively be an epoxy compound that contains no aromatic ring structure or aliphatic ring structure (also referred to as an “aliphatic epoxy”). The aliphatic epoxy compound may be a commercially available aliphatic epoxy compound. Examples of commercially available aliphatic epoxy compounds include neopentyl glycol diglycidyl ether (Nagase ChemteX Corporation “Denacol EX-211”), 1,6 hexanediol diglycidyl ether (Nagase ChemteX Corporation “Denacol EX-212P”), ethylene glycol diglycidyl ether (Nagase ChemteX Corporation “Denacol EX-810”), polyethylene glycol diglycidyl ether (Nagase ChemteX Corporation “Denacol EX-861”), propylene glycol diglycidyl ether (Nagase ChemteX Corporation “Denacol EX-911”), polypropylene glycol diglycidyl ether (Nagase ChemteX Corporation “Denacol EX-941, EX-920, and EX-931”), glycerol polyglycidyl ether (Sakamoto Yakuhin Kogyo Co., Ltd. “SR-GLG”), diglycerol polyglycidyl ether (Sakamoto Yakuhin Kogyo Co., Ltd. “SR-DGE”), trimethyloipropane polyglycidyl ether (Nagase ChemteX Corporation “Denacol EX-321”), pentaerythritol polyglycidyl ether (Nagase ChemteX Corporation “Denacol EX-411”), adipic acid diglycidyl ether (Nagase ChemteX Corporation “Denacol EX-701”), polyglycerol polyglycidyl ether (Sakamoto Yakuhin Kogyo Co., Ltd. “SR-40L”), sorbitol polyglycidyl ether (Sakamoto Yakuhin Kogyo Co., Ltd. “SR-SEP”), and polybutadiene epoxy resins (Daicel Corporation “EPOLEAD PB3600, Nagase ChemteX Corporation “Denacol R-15EPT,” “FCA-061L,” and “FCA-061M”).

The resin composition may contain an epoxy-containing silane coupling agent as an epoxy compound. Examples of epoxy-containing silane coupling agents include 3-glycidoxypropyltrimethoxysilane, 3-glycidoxypropyltriethoxysilane, 3-glycidoxypropylmethyldiethoxysilane, and 2-(3,4 epoxycyclohexyl)ethyltrimethoxysilane).

The epoxy compound(s) may be one epoxy compound used alone or may be multiple epoxy compounds used in combination.

The resin composition may be, depending on its purpose of use, cured through ring-opening polymerization of epoxy groups. The energy for initiating polymerization can be of any kind, but examples include heat and light. That is, the resin composition may be heat-curable or may be light-curable. If the resin composition is cured using heat, the resin composition may contain a curing agent. If the resin composition is cured using light, the resin composition may contain a photoinitiator.

The curing agent can be, for example, an amine-based curing agent, amide-based curing agent, acid anhydride-based curing agent, phenolic curing agent, active ester-based curing agent, carboxyl-containing curing agent, or thiol-based curing agent. The resin composition preferably contains at least one curing agent selected from the group consisting of anhydride-based curing agents, phenolic curing agents, and amide-based curing agents, more preferably at least one of an acid anhydride-based curing agent and a phenolic curing agent so that it will be even better in water vapor and oxygen barrier properties (e.g., oxygen barrier properties under high-humidity conditions). One of these curing agents may be used alone, or two or more may be used in combination.

Examples of amine-based curing agents include diaminodiphenylmethane, diaminodiphenylethane, diaminodiphenyl ether, diaminodiphenyl sulfone, orthophenylenediamine, metaphenylenediamine, paraphenylenediamine, metaxylenediamine, paraxylenediamine, diethyltoluenediamine, diethylenetriamine, triethylenetetramine, isophorone diamine, imidazole, BF₃-amine complexes, guanidine derivatives, and guanamine derivatives.

Examples of amide-based curing agents include dicyandiamide and polyamide resins. Polyamide resins are synthesized from a dimer of linolenic acid and ethylenediamine. For use as an amide-based curing agent, dicyandiamide is preferred because it makes the resin composition even better in water vapor and oxygen barrier properties (e.g., oxygen barrier properties under high-humidity conditions).

Examples of acid anhydride-based curing agents include succinic anhydride, phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, methylhexahydrophthalic anhydride, and alkenylsuccinic anhydrides. For use as an acid anhydride-based curing agent, methyltetrahydrophthalic anhydride is preferred because it makes the resin composition even better in water vapor and oxygen barrier properties (e.g., oxygen barrier properties under high-humidity conditions).

Examples of phenolic curing agents include those synthesized from a polyhydroxy compound and formaldehyde. The polyhydroxy compound can be, for example, bisphenol A, bisphenol F, bisphenol S, resorcinol, hydroquinone, fluorene bisphenol, 4,4′-biphenol, 4,4′,4″-trihydroxytriphenylmethane, 1,1,2,2-tetrakis(4-hydroxyphenyl)ethane, and calixarenes. Specific examples of phenolic curing agents include phenol novolac resins, cresol novolac resins, aromatic hydrocarbon formaldehyde resins, modified phenolic resins, dicyclopentadiene phenol adduct resins, phenol aralkyl resins (Xylok resins), and resorcinol novolac resins. For use as phenolic curing agents, phenol novolac resins are preferred because they make the resin composition even better in water vapor and oxygen barrier properties (oxygen barrier properties under high-humidity conditions).

Overall, the resin composition more preferably contains at least one curing agent selected from acid anhydride-based curing agents, phenol novolac resins, and dicyandiamide and more preferably contains at least one selected from the group consisting of methyltetrahydrophthalic anhydride, phenol novolac resins, and dicyandiamide.

If the resin composition is cured using heat, the resin composition may further contain a curing accelerator (curing catalyst). The curing accelerator may be used alone or may be used in combination with a curing agent as described above. The curing accelerator can be selected from various compounds that accelerate the curing of epoxy compounds. Examples of curing accelerators include phosphorus compounds, tertiary amine compounds, imidazole compounds, metal salts of organic acids, Lewis acids, and amine complex salts. Examples of phosphorus compounds include triphenylphosphine, triparatolyiphosphine, and diphenylcyclohexylphosphine. Examples of tertiary amine compounds include N,N-dimethylbenzylamine, 1,8-diazabicyclo[5.4.0]undecene-7,1,5-diazabicyclo[4.3.0]nonene-5, and tris(dimethylaminomethyl)phenol. Examples of imidazole compounds include 1-cyanoethyl-2-ethyl-4-methylimidazole and 2-ethyl-4-methylimidazole.

The photoinitiator can be any initiator for initiating ring-opening polymerization of epoxy groups by irradiation with light. For example, it may be a cationic photoinitiator. The photoinitiator may be of ionic photoacid generator type or of nonionic photoacid generator type.

The cationic photoinitiator of ionic photoacid generator type can be of any kind, and examples include onium salts, such as aromatic diazonium salts, aromatic halonium salts, and aromatic sulfonium salts, and organometallic complexes, such as iron-arene complexes, titanocene complexes, and aryl silanol-aluminum complexes. These cationic photoinitiators of ionic photoacid generator type may be used alone, or two or more may be used in combination.

The cationic photoinitiator of nonionic photoacid generator type can be of any kind, and examples include nitrobenzyl esters, sulfonic acid derivatives, phosphates, phenolsulfonates, diazonaphthoguinone, and N-hydroxyimidophosphonates. These cationic photoinitiators of nonionic photoacid generator type may be used alone, or two or more may be used in combination.

The photoinitiator loading of in the resin composition is not critical, but usually is between 0.1 and 10 parts by mass based on the whole amount of the resin composition as 100 parts by mass. That is, the photoinitiator loading of the resin composition may be 0.1 parts by mass or more and may be 10 parts by mass or less based on the whole amount of the resin composition as 100 parts by mass.

If the resin composition is cured using light, sensitizers may optionally be added to improve optical sensitivity and to give the composition sensitivity to the wavelengths of the light coming from the light source. These sensitizers may be used in combination with a photoinitiator as described above (e.g., a cationic photoinitiator) to adjust curability. Examples of sensitizers include anthracene compounds and thioxanthone compounds.

The light source used to initiate the photocuring of the resin composition only needs to be a light source that emits light of wavelengths absorbed by the photoinitiator and sensitizer used and usually is a source of light that includes wavelengths in the range of 200 to 450 nm. Specific examples of light sources that may be used include a high-pressure mercury lamp, an ultra-high-pressure mercury lamp, a metal-halide lamp, a high-power metal-halide lamp, a xenon lamp, a carbon arc lamp, and a light-emitting diode.

The resin composition may further contain a modifier. Examples of modifiers include coupling agents and silane compounds. One of these modifiers may be used alone, or multiple modifiers may be used in combination. If the resin composition contains any such modifier, the smectite with partially immobilized lithium is improved in wettability and therefore in dispersibility in the resin composition. The aforementioned acid anhydrides may be contained in the resin composition as modifiers.

Examples of coupling agents include silane coupling agents, titanium coupling agents, zirconium coupling agents, and aluminum coupling agents.

Examples of silane coupling agents include amino-containing silane coupling agents, (meth)acryl-containing silane coupling agents, and isocyanate-containing silane coupling agents. Examples of amino-containing silane coupling agents include 3-aminopropyltrimethoxysilane, N-2-(aminoethyl)-3-aminopropylmethyldimethoxysilane, 3-triethoxysilyl-N-(1,3-dimethylbutylidene)propylamine, and N-phenyl-γ-aminopropyltrimethoxysilane. Examples of (meth)acryl-containing silane coupling agents include 3-acryloxypropyltrimethoxysilane, 3-methacryloxypropyltrimethoxysilane, and 3-methacryloxypropyltriethoxysilane. An example of an isocyanate-containing silane coupling agent is 3-isocyanatopropyltriethoxysilane.

Examples of titanium coupling agents include isopropyl triisostearoyl titanate, isopropyl trioctanoyl titanate, isopropyl dimethacrylisostearoyl titanate, isopropyl isostearoyl diacryltitanate, isopropyl tris(dioctyl pyrophosphate) titanate, tetraoctyl his(ditridecyl phosphite)titanate, tetra(2,2-diallyloxymethyl-1-butyl) his(ditridecyl)phosphite titanate, bis(dioctyl pyrophosphate)oxyacetate titanate, and bis(dioctyl pyrophosphate) ethylene titanate.

Examples of zirconium coupling agents include zirconium acetate, ammonium zirconium carbonate, and zirconium fluoride.

Examples of aluminum coupling agents include acetalkoxyaluminum diisopropylate, aluminum diisopropoxymonoethylacetoacetate, aluminum tris ethylacetoacetate, and aluminum tris acetylacetonate.

Examples of silane compounds include alkoxysilanes, silazanes, and siloxanes. Examples of alkoxysilanes include methyltrimethoxysilane, dimethyldimethoxysilane, phenyltrimethoxysilane, methyltriethoxysilane, dimethyldiethoxysilane, phenyltriethoxysilane, n-propyltrimethoxysilane, n-propyltriethoxysilane, hexyltrimethoxysilane, hexyltriethoxysilane, octyltriethoxysilane, decyltrimethoxysilane, and 1,6-bis(trimethoxysilyl)hexane, trifluoropropyltrimethoxysilane. An example of a silazane is hexamethyldisilazane. An example of a siloxane is a siloxane that contains a hydrolyzable group.

The modifier loading is preferably between 0.1% and 50% by mass of the whole amount of the smectite with partially immobilized lithium. A modifier loading equal to or higher than 0.1% by mass results in better dispersibility of the smectite with partially immobilized lithium in the resin composition. A modifier loading equal to or lower than 50% by mass results in reduced impact of the modifier(s) on the mechanical characteristics of the resin composition. The modifier loading is preferably between 0.3% and 30% by mass, more preferably between 0.5% and 15% by mass.

The resin composition may contain a solvent, depending on its purpose of use. The solvent can be an organic solvent for example, such as methyl ethyl ketone, acetone, ethyl acetate, butyl acetate, toluene, dimethylformamide, acetonitrile, methyl isobutyl ketone, methanol, ethanol, propanol, methoxypropanol, cyclohexanone, methyl cellosolve, ethyl diglycol acetate, or propylene glycol monomethyl ether acetate. The solvent and its quantity can be selected as appropriate for the purpose of use.

The resin composition may contain additives (excluding compounds that meet the definition of an epoxy compound, a smectite with partially immobilized lithium, or a modifier) unless the advantages of the present invention are lost. Examples of additives include organic fillers, inorganic fillers, stabilizers (antioxidant, heat stabilizer, ultraviolet absorber, etc.), plasticizers, antistatic agents, lubricants, anti-blocking agents, coloring agents, nucleators, oxygen scavengers (compounds capable of trapping oxygen), and tackifiers. These additives are used alone, or two or more are used in combination.

Inorganic fillers as a type of additive include inorganic substances, such as metals, metal oxides, resins, and minerals, and composites thereof. Specific examples of inorganic fillers include silica, alumina, titanium, zirconia, copper, iron, silver, mica, talc, aluminum flakes, glass flakes, and clay minerals. Among these, it is particularly preferred to use a clay mineral for the purpose of improving gas barrier properties. Among clay minerals, the use of a swellable inorganic layer compound in particular is more preferred.

Examples of swellable inorganic layer compounds include silicate hydrates (e.g., phyllosilicate minerals), kaolinite clay minerals (e.g., halloysite), smectite clay minerals (e.g., montmorillonite, beidellite, nontronite, saponite, hectorite, sauconite, and stevensite), and vermiculite clay minerals (e.g., vermiculite). These minerals may be natural or synthesized clay minerals.

Examples of compounds capable of trapping oxygen include low-molecular-weight organic compounds that react with oxygen, such as hindered phenolic compounds, vitamin C, vitamin E, organic phosphorus compounds, gallic acid, and pyrogallol, and compounds of transition metals, such as cobalt, manganese, nickel, iron, and copper.

Examples of tackifiers include xylene resins, terpene resins, phenolic resins (excluding phenolic curing agents), and rosin resins. Adding a tackifier helps improve adhesion to film materials upon application. The amount of tackifier added is preferably between 0.01 and 5 parts by mass based on the whole amount of the resin composition as 100 parts by mass.

A molded article according to an embodiment can be obtained by molding a resin composition as described above. The molding method is at the manufacturer's discretion and can be selected in accordance with the purpose of use when appropriate. The molded article may be from the resin composition or may be from the cured form of the resin composition. The molded article can be in any shape; it may be shaped like a plate, sheet, or film, may have a three-dimensional shape, may be a coating on a substrate, or may be one molded to be present between a substrate and a substrate.

If a plate- or sheet-shaped article is fabricated, possible methods include methods in which the resin composition is molded, for example using extrusion molding, flat stamping, profile extrusion molding, blow molding, compression molding, vacuum molding, or injection molding. If a film-shaped article is fabricated, examples of possible methods include hot melt extrusion, polymer solution casting, inflation film molding, cast molding, extrusion laminating, calender molding, sheet forming, fiber molding, blow molding, injection molding, rotational molding, and coating. If the resin composition is one that cures when exposed to heat or active energy radiation, the resin composition may be molded using curing methods in which heat or active energy radiation is employed.

If the resin composition is liquid, it may be molded by coating. Examples of possible coating methods include spraying, spin coating, dipping, roll coating, blade coating, doctor roll coating, doctor blading, curtain coating, slit coating, screen printing, inkjet coating, and dispensing.

A laminate according to an embodiment is one that has a molded article as described above on a substrate. The laminate may have a two-layer structure, a three-layer structure, or have more layers.

The material for the substrate is not critical and can be selected as appropriate for the purpose of use. The substrate can be made of, for example, wood, metal, plastic, paper, silicone, or a modified silicone or may be a substrate obtained by joining different materials together. The substrate can be in any shape; it may be shaped like a flat plate, a sheet, a three-dimensional shape having curvature throughout or in part of it, or any other shape selected in accordance with the purpose. The hardness, thickness, etc., of the substrate are not critical either.

The laminate can be obtained by laminating the substrate with a molded article as described above. The molded article with which the substrate is laminated may be formed by directly coating the substrate with the resin composition or molding the resin composition directly on the substrate, or an article molded from the resin composition may be placed. For direct coating, the coating method is not critical, and examples of possible methods include spraying, spin coating, dipping, roll coating, blade coating, doctor roll coating, doctor blading, curtain coating, slit coating, screen printing, and inkjet coating. For direct molding, examples of possible molding methods include in-mold forming, film insert molding, vacuum molding, extrusion laminating, and stamping. If an article molded from the resin composition is placed, a layer of uncured or partially cured resin composition may be placed on the substrate and then cured, or a layer of completely cured resin composition may be placed on the substrate.

Alternatively, the laminate may be obtained by coating cured resin composition with a precursor to the substrate and then curing the precursor or may be obtained by bonding together a precursor to the substrate and the resin composition with one of them uncured or partially cured and then curing the uncured or partially cured member. The precursor to the substrate can be any substance, and examples include curable resin compositions. The laminate may be prepared by using a resin composition according to an embodiment as an adhesive.

The resin composition described hereinabove is suitable for use as a gas barrier material by virtue of being superior in water vapor and oxygen barrier properties. The gas barrier material only needs to be one that contains a resin composition as described above.

The resin composition described hereinabove, moreover, is suitable for use as a coating material. The coating material only needs to be one that contains a resin composition as described above. The coating material can be in any form as long as it satisfies requirements on characteristics for use as a barrier coating material. For example, a heat-curable coating material may be a one-component coating material, made by adding a smectite with partially immobilized lithium to a premix of an epoxy compound and a curing agent, or may be a two-component mixture-type coating material, a coating material formed by an epoxy compound and a separate curing agent. If the coating material is of two-component mixture type, one or both of the epoxy compound and the curing agent may be premixed with the smectite with partially immobilized lithium.

The method of coating with the coating material is not critical. Examples of specific methods include coating methods such as roll coating and gravure coating. The coater is not critical either. By virtue of having high gas barrier properties, the resin composition described hereinabove can be suitably used as a coating material for gas barrier purposes.

The resin composition described hereinabove, moreover, is suitable for use as an adhesive by virtue of being superior in adhesiveness. The adhesive only needs to be one that contains a resin composition as described above. The adhesive can be in any form; it may be a liquid or paste adhesive or may be a solid adhesive. By virtue of having high gas barrier properties, the resin composition can be suitably used as an adhesive for gas barrier purposes.

A liquid or paste adhesive may be a one-component adhesive or may be a two-component adhesive, an adhesive that comes with a separate curing agent. It is not critical how the liquid or paste adhesive is used, but the user may apply it to one of the surfaces to be bonded and join by sticking the other surface to the first one or pour the adhesive between the surfaces to be bonded and then join the surfaces together.

In the case of a solid adhesive, the user may place a powder, chip, or sheet shaped from the adhesive between the surfaces to be bonded, join the surfaces together by thermally melting the adhesive, and cure the adhesive.

### EXAMPLES

The following describes the present invention in further detail by examples, but the present invention is not limited to these.

The filler to be contained in the resin composition was a smectite with partially immobilized lithium or a smectite without partially immobilized lithium. The smectite with partially immobilized lithium was a montmorillonite slurry available from Kunimine Industries Co., Ltd. (trade name, RCEC-W; cation exchange capacity, 39.0 meg/100 g). The amount (w/w%) of the smectite with partially immobilized lithium in this dispersion slurry was 20 w/w%. The smectite without partially immobilized lithium was natural montmorillonite (trade name, KUNIPIA-E; cation exchange capacity, 108 meq/100 g; Kunimine Industries Co., Ltd.) (KUNIPIA is a registered trademark).

The modifier was KBM-503, a silane coupling agent (3-methacryloxypropyltrimethoxysilane, trade name, Shin-Etsu Chemical Co., Ltd.), or KBM-3033, a silane compound (n-propyltrimethoxysilane, trade name, Shin-Etsu Chemical Co., Ltd.).

### Example 1

To 100 parts by mass of a bisphenol-A liquid epoxy compound (trade name, EPICLON 850-S; DIC Corporation), 210 parts by mass of the slurry of a smectite with partially immobilized lithium, 384 parts by mass of acetonitrile, 43 parts by mass of water, and 93 parts by mass of 2-propanol as solvents, and 59.5 parts by mass of a modifier solution were added. The materials were kept under stirring for 8 hours. Then 90 parts by mass of methyltetrahydrophthalic anhydride (trade name, EPICLON B-570H; DIC Corporation) and 1 part by mass of N,N-dimethylbenzylamine (Wako Pure Chemical Industries, Ltd.) were added. In this way, a resin composition of Example 1 was obtained. This composition was named liquid coating 1. The modifier solution was prepared by stirring for 2 hours a solution made with 2.8 parts by mass of KBM-503, 0.6 parts by mass of water, 56.0 parts by mass of 2-propanol, and 0.1 parts by mass of hydrochloric acid (concentration: 0.1 mol/1).

A 25-μm polyimide film (Kapton film, Du Pont-Toray Co., Ltd.) (Kapton is a registered trademark; the same applies hereinafter) was coated with the resulting liquid coating 1 using a bar coater to a dry coating thickness of 2 μm. Shorty after coating, the coated polyimide film was heated in a drying oven at 120° C. for 1 minute. The film was then heated in a drying oven at 120° C. for 3 hours and then heated in a drying oven at 175° C. for 5 hours. In this way, an article molded from the resin composition of Example 1 was formed on the polyimide film, and a film laminate of Example 1 was obtained.

In the resin composition and molded article of Example 1, the amount of the smectite with partially immobilized lithium (filler content) was 18% by mass of the total nonvolatile content.

### Examples 2 to 10

Resin compositions of Examples 2 to 10 were obtained as in Example 1 except that EPICLON 850-S was replaced with the epoxy compound specified in Table 1, that the solvent acetonitrile and water were replaced with methyl ethyl ketone (MEK) in some examples (See Examples 5 and 6.), that the amounts of each ingredient were changed to the values given in Table 1, and that the modifier solution was a modifier solution prepared to the formula given in Table 1. These compositions were named liquid coatings 2 to 10, respectively. The amount of modifier solution used was the total of the amounts of each ingredient used to prepare the solution, specified in Table 1. In Examples 2 to 6 and 10, the epoxy compound was dissolved in a small amount of MEK before use. In Examples 2 to 4 and 10, 100 parts by mass of the epoxy compound was dissolved in 42.9 parts by mass of MEK. In Example 5, 100 parts by mass of the epoxy compound was dissolved in 78.6 parts by mass of MEK. In Example 6, 100 parts by mass of the epoxy compound was dissolved in 150 parts by mass of MEK.

Then articles molded from the resin compositions of Examples 2 to 10 were formed on 25-μm polyimide films (Kapton film, Du Pont-Toray Co., Ltd.) as in Example 1 except that liquid coating 1 was replaced with liquid coatings 2 to 10, respectively. In this way, film laminates of Examples 2 to 10 were obtained.

In all of the resin compositions and molded articles of Examples 2 to 10, the amount of the smectite with partially immobilized lithium (filler content) was 18% by mass of the total nonvolatile content. [0091]

### Examples 11 to 13

Resin compositions of Examples 11 to 13 were obtained as in Example 1 except that B-570H was replaced with the curing agent specified in Table 2, that the catalyst (curing accelerator) N,N-dimethylbenzylamine was not used, that the solvent water was not used in an example (See Example 12.), that the amounts of each ingredient were changed to the values given in Table 2, and that the modifier solution was a modifier solution prepared to the formula given in Table 2. These compositions were named liquid coatings 11 to 13, respectively. The amount of modifier solution used was the total of the amounts of each ingredient used to prepare the solution, specified in Table 2.

Then articles molded from the resin compositions of Examples 11 to 13 were formed on 25-μm polyimide films (Kapton film, Du Pont-Toray Co., Ltd.) as in Example 1 except that liquid coating 1 was replaced with liquid coatings 11 to 13, respectively. In this way, film laminates of Examples 11 to 13 were obtained.

In all of the resin compositions and molded articles of Examples 11 to 13, the amount of the smectite with partially immobilized lithium (filler content) was 18% by mass of the total nonvolatile content.

### Example 14

A resin composition of Example 14 was obtained as in Example 1 except that the modifier KBM-503 was replaced with KBM3033, that the amounts of each ingredient were changed to the values given in Table 2, and that the modifier solution was a modifier solution prepared to the formula given in Table 2. This composition was named liquid coating 14. The amount of modifier solution used was the total of the amounts of each ingredient used to prepare the solution, specified in Table 2.

Then an article molded from the resin composition of Example 14 was formed on a 25-μm polyimide film (Kapton film, Du Pont-Toray Co., Ltd.) as in Example 1 except that liquid coating 1 was replaced with liquid coating 14. In this way, a film laminate of Example 14 was obtained.

In the resin composition and molded article of Example 14, the amount of the smectite with partially immobilized lithium (filler content) was 18% by mass of the total nonvolatile content.

### Examples 15 to 18

Resin compositions of Examples 15 to 18 were obtained as in Example 1 except that the amounts of each ingredient were changed to the values given in Table 2 and that the modifier solution was a modifier solution prepared to the formula given in Table 2. These compositions were named liquid coatings 15 to 18, respectively. The amount of modifier solution used was the total of the amounts of each ingredient used to prepare the solution, specified in Table 2.

Then articles molded from the resin compositions of Examples 15 to 18 were formed on 25-μm polyimide films (Kapton film, Du Pont-Toray Co., Ltd.) as in Example 1 except that liquid coating 1 was replaced with liquid coatings 15 to 18, respectively. In this way, film laminates of Examples 15 to 18 were obtained.

In the resin compositions and molded articles of Examples 15 to 18, the amounts of the smectite with partially immobilized lithium (filler content levels) were 5% by mass, 10% by mass, 30% by mass, and 70% by mass, respectively, of the total nonvolatile content.

### Comparative Example 1

To 100 parts by mass of a bisphenol-A liquid epoxy compound (trade name, EPICLON 850-S; DIC Corporation), 446 parts by mass of the natural montmorillonite (KUNIPIA-F), 3841 parts by mass of acetonitrile, 427 parts by mass of water, and 64 parts by mass of 2-propanol as solvents, and 126.5 parts by mass of a modifier solution were added. The materials were kept under stirring for 8 hours. Then 90 parts by mass of methyltetrahydrophthalic anhydride (trade name, EPICLON B-570H; DIC Corporation) and 1 part by mass of N,N-dimethylbenzylamine (Wako Pure Chemical Industries, Ltd.) were added. In this way, a resin composition of Comparative Example 1 was obtained. This composition was named liquid coating 19. The modifier solution was prepared by stirring for 2 hours a solution made with 24.2 parts by mass of KBM503, 5.3 parts by mass of water, 97.0 parts by mass of 2-propanol, and 0.1 parts by mass of hydrochloric acid (concentration: 0.1 mol/1).

An article molded from the resin composition of Comparative Example 1 was formed as in Example 1 except that liquid coating 1 was replaced with liquid coating 19. In this way, a film laminate of Comparative Example 1 was obtained.

In the resin composition and molded article of Comparative Example 1, the amount of the natural montmorillonite (filler content) was 70% by mass of the total nonvolatile content, and the modifier loading (modifier content) was 5% by mass of the whole amount of the natural montmorillonite (filler).

### Comparative Example 2

To 100 parts by mass of a bisphenol-A liquid epoxy compound (trade name, EPICLON 850-S; DIC Corporation), 500 parts by mass of acetonitrile was added. The materials were kept under stirring for 8 hours. Then 90 parts by mass of methyltetrahydrophthalic anhydride (trade name, EPICLON B-570H; DIC Corporation) and 1 part by mass of N,N-dimethylbenzylamine (Wako Pure Chemical Industries, Ltd.) were added. In this way, a resin composition of Comparative Example 2 was obtained. This composition was named liquid coating 20.

An article molded from the resin composition of Comparative Example 2 was formed as in Example 1 except that liquid coating 1 was replaced with liquid coating 20. In this way, a film laminate of Comparative Example 2 was obtained.

### <Testing>

The film laminates of Examples 1 to 18 and Comparative Examples 1 and 2 were tested for film formation, oxygen permeability, and water vapor permeability. The test results are presented in Tables 1 and 2. The tests for film formation, oxygen permeability, and water vapor permeability were performed as follows.

### (Film Formation)

Film formation was graded “A” if the coated surface of the film laminate was smooth or “B” if the coated surface was not smooth.

### (Oxygen Permeability)

The measurement of oxygen permeability was conducted in an atmosphere at a temperature of 23° C. and a humidity of 0% RH and in an atmosphere at a temperature 23° C. and a humidity of 90% RH using MOCON OX-TRAN 1/50 oxygen transmission rate test system in accordance with JIS-K7126 (equal-pressure method). RH stands for relative humidity.

### (Water Vapor Permeability)

The measurement of water vapor permeability was conducted in an atmosphere at a temperature of 40° C. and a humidity of 90% RH using Systech Illinois 7001 water vapor permeation analyzer in accordance with JIS-K7129.

TABLE 1

| | | Epoxy | | | | | |
|---|---|---|---|---|---|---|---|
| | | equivalent | | | | | |
| | | weight | Example 1 | Example 2 | Example 3 | Example 4 | Example 5 |
| Epoxy | EP850S | 185 | 100 | — | — | — | — |
| compounds | SP1050 | 500 | — | 100 | — | — | — |
| | SP2050 | 650 | — | — | 100 | — | — |
| | SP4050 | 1000 | — | — | — | 100 | — |
| | SP7050 | 2100 | — | — | — | — | 100 |
| | HM-091 | 2310 | — | — | — | — | — |
| | EP830 | 170 | — | — | — | — | — |
| | 2021P | 130 | — | — | — | — | — |
| | EX-212 | 116 | — | — | — | — | — |
| | EX-861 | 550 | — | — | — | — | — |
| Fillers | RCEC-W(NV20%) | — | 210 | 152 | 140 | 130 | 121 |
| | KUNIPIA-F | — | — | — | — | — | — |
| Solvents | Methyl ethyl ketone | — | — | — | — | — | 427 |
| | Acetonitrile | — | 384 | 384 | 384 | 384 | — |
| | 2-Propanol | — | 93 | 133 | 136 | 138 | 141 |
| | Water | — | 43 | 43 | 43 | 43 | — |
| Modifier | KBM-503 | — | 2.8 | 2.1 | 1.9 | 1.8 | 1.7 |
| solution | KBM-3033 | — | — | — | — | — | — |
| | Water | — | 0.6 | 0.5 | 0.4 | 0.4 | 0.4 |
| | 2-Propanol | — | 56.0 | 86.0 | 86.0 | 86.0 | 85.0 |
| | 0.1 mol/l HCl | — | 0.1 | 0.1 | 0.1 | 0.1 | 0.1 |
| Curing | B-570H | — | 90 | 37 | 26 | 18 | 9 |
| agents | DICY7 | — | — | — | — | — | — |
| | TD-2090 | — | — | — | — | — | — |
| | IPD | — | — | — | — | — | — |
| Catalyst | N,N-dimethylbenzylamine | — | 1 | 1 | 1 | 1 | 1 |
| Filler content (% by mass) | | | 18 | 18 | 18 | 18 | 18 |
| Film formation | | | A | A | A | A | A |
| Oxygen permeability 0% RH (cc/m² · day · atm) | | | 4 | 5 | 7 | 10 | 21 |
| Oxygen permeability 90% RH (cc/m² · day · atm) | | | 8 | 10 | 10 | 12 | 18 |
| Water vapor permeability (g/m² · day) | | | 4 | 4 | 5 | 7 | 15 |
| | | Epoxy | | | | | |
| | | equivalent | | | | | Example |
| | | weight | Example 6 | Example 7 | Example 8 | Example 9 | 10 |
| Epoxy | EP850S | 185 | — | — | — | — | — |
| compounds | SP1050 | 500 | — | — | — | — | — |
| | SP2050 | 650 | — | — | — | — | — |
| | SP4050 | 1000 | — | — | — | — | — |
| | SP7050 | 2100 | — | — | — | — | — |
| | HM-091 | 2310 | 100 | — | — | — | — |
| | EP830 | 170 | — | 100 | — | — | — |
| | 2021P | 130 | — | — | 100 | — | — |
| | EX-212 | 116 | — | — | — | 100 | — |
| | EX-861 | 550 | — | — | — | — | 100 |
| Fillers | RCEC-W(NV20%) | — | 119 | 221 | 250 | 268 | 144 |
| | KUNIPIA-F | — | — | — | — | — | — |
| Solvents | Methyl ethyl ketone | — | 427 | — | — | — | — |
| | Acetonitrile | — | — | 384 | 384 | 384 | 384 |
| | 2-Propanol | — | 141 | 112 | 108 | 104 | 135 |
| | Water | — | — | 43 | 43 | 43 | 43 |
| Modifier | KBM-503 | — | 1.6 | 3.0 | 3.5 | 3.7 | 2.0 |
| solution | KBM-3033 | — | — | — | — | — | — |
| | Water | — | 0,4 | 0.6 | 0.8 | 0.8 | 0.4 |
| | 2-Propanol | — | 85.0 | 59.0 | 85.0 | 85.0 | 86.0 |
| | 0.1 mol/l HCl | — | 0.1 | 0.1 | 0.1 | 0.1 | 0.1 |
| Curing | B-570H | — | 7 | 100 | 127 | 143 | 30 |
| agents | DICY7 | — | — | — | — | — | — |
| | TD-2090 | — | — | — | — | — | — |
| | IPD | — | — | — | — | — | — |
| Catalyst | N,N-dimethylbenzylamine | — | 1 | 1 | 1 | 1 | 1 |

| | | | | | |
|---|---|---|---|---|---|
| Filler content (% by mass) | 18 | 18 | 18 | 18 | 18 |
| Film formation | A | A | A | A | A |
| Oxygen permeability 0% RH (cc/m² · day · atm) | 90 | 2 | 10 | 20 | 67 |
| Oxygen permeability 90% RH (cc/m² · day · atm) | 56 | 3 | 11 | 22 | 88 |
| Water vapor permeability (g/m² · day) | 32 | 3 | 13 | 23 | 36 |

TABLE 2

| | | Epoxy | | | | | | |
|---|---|---|---|---|---|---|---|---|
| | | equivalent | Example | Example | Example | Example | Example | Example |
| | | weight | 11 | 12 | 13 | 14 | 15 | 16 |
| Epoxy | EP850S | 185 | 100 | 100 | 100 | 100 | 100 | 100 |
| compounds | SP1050 | 500 | — | — | — | — | — | — |
| | SP2050 | 650 | — | — | — | — | — | — |
| | SP4050 | 1000 | — | — | — | — | — | — |
| | SP7050 | 2100 | — | — | — | — | — | — |
| | HM-091 | 2310 | — | — | — | — | — | — |
| | EP830 | 170 | — | — | — | — | — | — |
| | 2021P | 130 | — | — | — | — | — | — |
| | EX-212 | 116 | — | — | — | — | — | — |
| | EX-861 | 550 | — | — | — | — | — | — |
| Fillers | RCEC-W(NV20%) | — | 115 | 170 | 137 | 210 | 50 | 106 |
| | KUNIPIA-F | — | — | — | — | — | — | — |
| Solvents | Methyl ethyl ketone | — | — | — | — | — | — | — |
| | Acetonitrile | — | 384 | 427 | 384 | 384 | 384 | 384 |
| | 2-Propanol | — | 140 | 83 | 137 | 106 | 158 | 144 |
| | Water | — | 43 | — | 43 | 43 | 43 | 43 |
| Modifier | KBM-503 | — | 1.6 | 2.4 | 1.9 | — | 0.7 | 1.5 |
| solution | KBM-3033 | — | — | — | — | 6.5 | | |
| | Water | — | 0.3 | 0.5 | 0.4 | 2.2 | 0.2 | 0.3 |
| | 2-Propanol | — | 85.0 | 85.0 | 85.0 | 65.0 | 85.0 | 85.0 |
| | 0.1 mol/l HCl | — | 0.1 | 0.1 | 0.1 | 0.1 | 0.1 | 0.1 |
| Curing | B-570H | — | | | | 90 | 90 | 90 |
| agents | DICY7 | — | 5 | | | | | |
| | TD-2090 | — | | 55 | | | | |
| | IPD | — | | | 24 | | | |
| Catalyst | N,N-dimethylbenzylamine | — | — | — | — | 1 | 1 | 1 |

| | | | | | | |
|---|---|---|---|---|---|---|
| Filler content (% by mass) | 18 | 18 | 18 | 18 | 5 | 10 |
| Film formation | A | A | A | A | A | A |
| Oxygen permeability 0% RH (cc/m² · day · atm) | 16 | 5 | 72 | 19 | 15 | 8 |
| Oxygen permeability 90% RH (cc/m² · day · atm) | 10 | 2 | 39 | 10 | 18 | 12 |
| Water vapor permeability (g/m² · day) | 12 | 4 | 18 | 8 | 14 | 10 |

| | | Epoxy | | | | |
|---|---|---|---|---|---|---|
| | | equivalent | Example | Example | Comparative | Comparative |
| | | weight | 17 | 18 | Example 1 | Example 2 |
| Epoxy | EP850S | 185 | 100 | 100 | 100 | 100 |
| compounds | SP1050 | 500 | — | — | — | — |
| | SP2050 | 650 | — | — | — | — |
| | SP4050 | 1000 | — | — | — | — |
| | SP7050 | 2100 | — | — | — | — |
| | HM-091 | 2310 | — | — | — | — |
| | EP830 | 170 | — | — | — | — |
| | 2021P | 130 | — | — | — | |
| | EX-212 | 116 | — | — | — | — |
| | EX-861 | 550 | — | — | — | — |
| Fillers | RCEC-W(NV20%) | — | 409 | 2228 | — | — |
| | KUNIPIA-F | — | — | — | 446 | — |
| Solvents | Methyl ethyl ketone | — | — | — | — | — |
| | Acetonitrile | — | 384 | 3841 | 3841 | 500 |
| | 2-Propanol | — | 68 | 64 | 64 | — |
| | Water | — | 43 | 427 | 427 | — |
| Modifier | KBM-503 | — | 5.7 | 24.2 | 24.2 | — |
| solution | KBM-3033 | — | | — | — | — |
| | Water | — | 1.2 | 5.3 | 5.3 | — |
| | 2-Propanol | — | 85.0 | 97.0 | 97.0 | — |
| | 0.1 mol/l HCl | — | 0.1 | 1.0 | 1.0 | — |
| Curing | B-570H | — | 90 | 90 | 90 | 90 |
| agents | DICY7 | — | | | — | — |
| | TD-2090 | — | | | — | — |
| | IPD | — | | | — | — |
| Catalyst | N,N-dimethylbenzylamine | — | 1 | 1 | 1 | 1 |

| | | | | |
|---|---|---|---|---|
| Filler content (% by mass) | 30 | 70 | 70 | — |
| Film formation | A | B | B | A |
| Oxygen permeability 0% RH (cc/m² · day · atm) | 5 | 102 | 157 | 204 |
| Oxygen permeability 90% RH (cc/m² · day · atm) | 7 | 70 | 90 | 99 |
| Water vapor permeability (g/m² · day) | 5 | 42 | 60 | 62 |

The details of the epoxy compounds and curing agents listed in Tables 1 and 2 are as follows.

### [Aromatic Epoxy Compounds]

EP850S: A bisphenol-A liquid epoxy compound; trade name, EPICLON 850-S; DIC Corporation; epoxy equivalent weight, 185 g/eq
EP1050: A bisphenol-A solid epoxy compound; trade name, EPICLON 1050; DIC Corporation; epoxy equivalent weight, 500 g/eq
EP2050: A bisphenol-A solid epoxy compound; trade name, EPICLON 2050; DIC Corporation; epoxy equivalent weight, 650 g/eq
EP4050: A bisphenol-A solid epoxy compound; trade name, EPICLON 4050; DIC Corporation; epoxy equivalent weight, 1000 g/eq
E07050: A bisphenol-A solid epoxy compound; trade name, EPICLON 7050; DIC Corporation; epoxy equivalent weight, 2100 g/eq
HM-091: A bisphenol-A solid epoxy compound; trade name, EPICLON HM-091; DIC Corporation; epoxy equivalent weight, 2310 g/eq
EP830: A bisphenol-F epoxy compound; trade name, EPICLON 830; DIC Corporation; epoxy equivalent weight, 170 g/eq

### [Alicyclic Epoxy Compound]

2021P: 3,4-Epoxycyclohexylmethyl-3′,4′-epoxycyclohexane carboxylate; trade name, CELLOXIDE 2021P; Daicel Corporation; epoxy equivalent weight, 130 g/eq

### [Aliphatic Epoxy Compounds]

EX-212: 1,6 Hexanediol diglycidyl ether; trade name, Denacol EX-212; Nagase ChemteX Corporation; epoxy equivalent weight, 116 g/eq
EX-861: Polyethylene glycol diglycidyl ether; trade name, Denacol EX-861; Nagase ChemteX Corporation; epoxy equivalent weight, 550 g/eq

### [Acid Anhydride-Based Curing Agent]

H-570H: Methyltetrahydrophthalic anhydride; trade name, EPICLON B-570H; DIC Corporation

### [Amide-Based Curing Agent]

DICY7: Dicyandiamide, trade name, Mitsubishi Chemical Corporation

### [Phenolic Curing Agent]

TD-2090: A phenol novolac resin; trade name, PHENOLITE TD-2090; DIC Corporation

### [Amine-Based Curing Agent]

IPD: Isophorone diamine; trade name, VESTAMIN IPD; EVONIK

### INDUSTRIAL APPLICABILITY

The resin composition according to the present invention can be suitably used in various fields, including packaging materials and also electronic materials and building materials, by virtue of being superior in gas barrier properties, in particular water vapor and oxygen barrier properties.

1. A resin composition comprising an epoxy compound and a smectite with partially immobilized lithium.

2. The resin composition according to claim 1, wherein the epoxy compound has an epoxy equivalent weight of 50 to 3000 g/eq.

3. The resin composition according to claim 1, wherein the epoxy compound has at least one structure of an aromatic ring structure and an aliphatic ring structure.

4. The resin composition according to claim 1, wherein the smectite with partially immobilized lithium has a cation exchange capacity of 1 to 70 meq/100 g.

5. The resin composition according to claim 1, further comprising at least one curing agent.

6. The resin composition according to claim 5, wherein the curing agent is at least one curing agent selected from the group consisting of acid anhydride-based curing agents, phenolic curing agents, and amide-based curing agents.

7. The resin composition according to claim 1, wherein the smectite with partially immobilized lithium is present in an amount of 3% to 70% by mass based on total nonvolatile content of the resin composition.

8. An article molded from a resin composition according to claim 1.

9. A laminate comprising a substrate and a molded article according to claim 8 on the substrate.

10. A gas barrier material comprising a resin composition according to claim 1.

11. A coating material comprising a resin composition according to claim 1.

12. An adhesive comprising a resin composition according to claim 1.
